(19) United States
(12) Patent Application Publication
(10) Pub. No.: US 2015/0253462 A1
(43) Pub. Date: Sep. 10, 2015

(54) INSTANTANEOUS ENVIRONMENT DETECTION DEVICE AND OPERATION METHOD THEREOF

(71) Applicants: WEI-YU CHEN, New Taipei City (TW); Lin-Lang Chan, Taichung City (TW)

(72) Inventors: WEI-YU CHEN, New Taipei City (TW); Lin-Lang Chan, Taichung City (TW)

(21) Appl. No.: 14/200,022

(22) Filed: Mar. 7, 2014

(51) Int. Cl. G01W 1/00

(52) U.S. Cl. CPC G01W 1/00

(57) ABSTRACT

The present invention provides an instantaneous detection device and an application thereof, which can be easily combined with a portable electronic device for timely detection of surrounding temperature and humidity and UV index and can be used in combination with an APP platform for transmission and connection with associated information to provide an operation of personal security protection, in which a detection device body that includes detectors for temperature and humidity and UV light mounted thereto is directly inserted into a socket of a portable electronic device so that through modulation processing with a built-in microprocessor and connection with a mobile electronic device through a phone jack plug, a user is provided with instantaneous and accurate detection of local environmental temperature and humidity and UV value of sunlight through the mobile positioning device, together with the built-in APP platform, to transmit the detection data to a database.

### (a) TECHNICAL FIELD OF THE INVENTION

The present invention generally relates to an instantaneous environment detection device and application thereof, which is a design and an application of a portable environment detection device that is easily combinable with a portable electronic device to provide instantaneous environment detection, direct connection with associated database for efficient data integration and recording and consumption returning service.

### (b) DESCRIPTION OF THE PRIOR ART

Modern people are controlled by surrounding environmental factors, such as weather, for both travel and work and it is only possible to achieve detection of temperature and UV index at a location by means of the supply of data from a weather agency or associated traditional weather-related hazard facility. The weather agency relies on detection made with the special detection instrument or facility installed at various sites, together with associated data computation, to determine various data for weather report, such as wearing heavy clothing or the grade of sun burn lotion applied for swimming or aridity temperature/humidity conversion to serve as a reference for selection of for example application of lotion for wet preserving for reference for taking a trip. However, such data are generally provided for a large area and it is hard to precisely determine the actual environmental condition of the spot where a person is located and when uses are made, particularly, weather being under a condition of rapid change in recent years so that the temperature and humidity and sun burn index of the surrounding environment change rapidly and may get greatly different for positional differences including different locations and different radiation angles. For the same latitude, the environmental condition may be different due to the difference of altitude and surrounding terrain. Modern people have a great amount of outdoor activities that are often held at extreme areas of high mountains and seashores. The data provided by weather agency that is obtained for fixed sites may not be practical. It can be easily imaged that by taking the differences of personal body quality and actual time and locations into consideration, it is extremely hard for a general user to acquire accurate and reliable localized environmental data. Particularly, for activities taken in mountains or seashores, accurately acquiring UV value of sunlight and instantaneous temperature and humidity detection and selecting proper grade of sun burn lotion are often such that it is not possible to perform instantaneous accurate detection of the surroundings and correct selection so as to result in unnecessary sun burn. Similarly, for detection of environmental temperature, the same concern exists, where the associated environmental conditions cannot be instantaneously acquired and correct protection information cannot be obtained timely so that it is not possible to take correct and correspondingly effective protection measures and discomfort of body or clothing wearing may result. It is desired to improve such deficiency of living functionality. Actually, for the modern networked mobile era when mobile electronic devices are prevailing, where popularity of mobile phone is such that almost everybody has one or more mobile phones that might be integrated with global positioning functions, it is desired to use such a positioning function in combination with special detection device for operation, together with connection with proper network database, in order to effectively suit the need of the general consumers who desire delicate data of weather that the currently weather report cannot meet. To suit the need for comfortable and secured living for modern people, it is desired to make further development and improvement.

### SUMMARY OF THE INVENTION

The present inventor is a professional manufacturer of electronic and makeup products and is fully aware of the various deficiencies and drawbacks of living functions resulting from deficiency of the traditional weather detection that cannot suit the need for instantaneous weather detection, so that based on years' experience of development of related products, in light of detection device and mobile phone or portable electronic mobile device in combination of network connection and synchronous processing techniques, an instantaneous environment detection device and an application thereof according to the present invention are proposed, where a detection device body including a temperature/humidity detector and a UV light photo-detector is directly inserted into a socket of a mobile phone for connection, whereby with the positioning assistance provided by the smart mobile electronic device, instantaneous detection of the surrounding temperature, humidity, and UV value of ultraviolet light can be made to provide a user with a returning answer for correct selection and suggestion in respect of living functionality so as to improve the various inconveniences and drawbacks associated with security resulting from the environmental factors.

The primary object of the present invention is such that a device body to which a temperature/humidity detector and a UV photo-detector are mounted uses modulation processing built in a microprocessor, together with connection through a phone jack plug of a mobile device, through network connection with product suppliers' database through APP platform, according to setting and selection of special returning answer paths, a consumers may easily and correctly acquire instantaneous local environmental data detection, together with answers from the database, to achieve assistance for security of living functionality, also allowing for collection and statistics of data of actual purchasing in order to ensure living and consuming functionality and business service to truly meet the purposes and effectiveness of use for comfortableness and safety.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing the structure of a detection device according to the present invention.

FIG. 2 is a plan view of the structure of the detection device of the present invention.

FIG. 3 is a perspective view illustrating the detection device of the present invention combined with a mobile phone.

FIG. 4 is a schematic view illustrating operation control of the detection device of the present invention.

FIG. 5 is a schematic view showing a UV light detection and control circuit of the present invention.

FIG. 6 is a schematic view showing transmission and connection of the present invention through a network for business.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

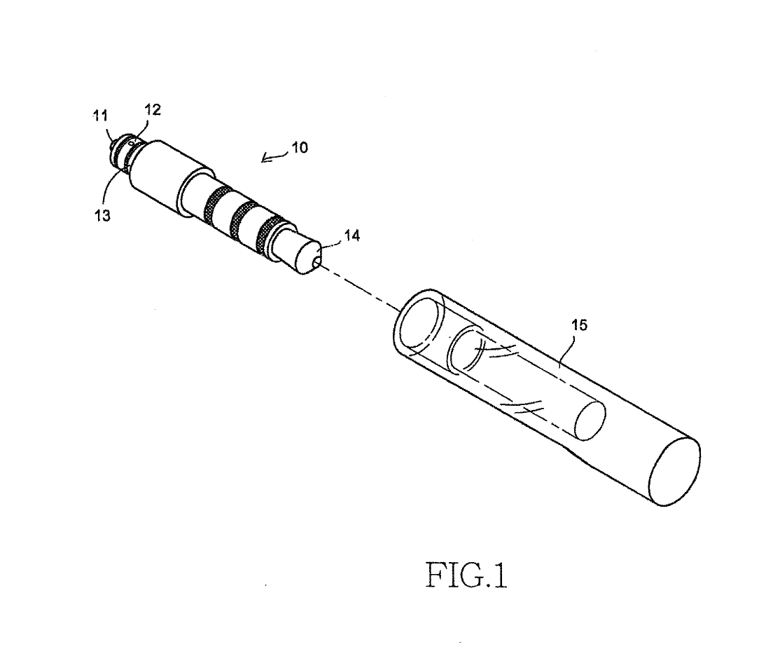

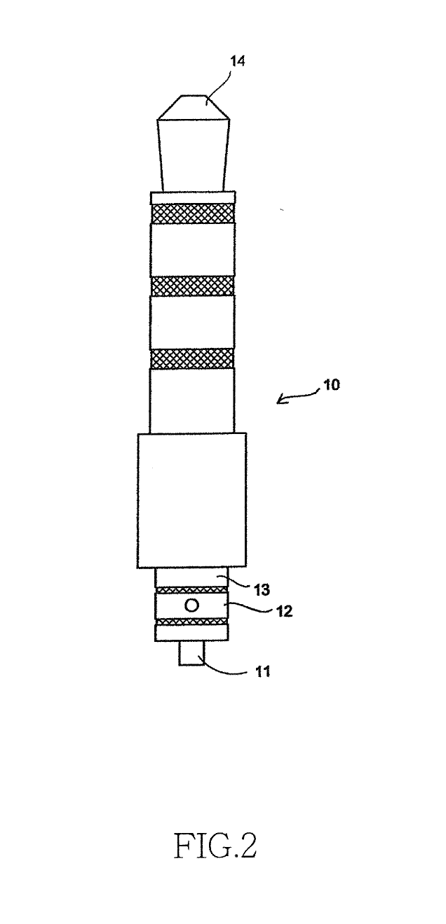

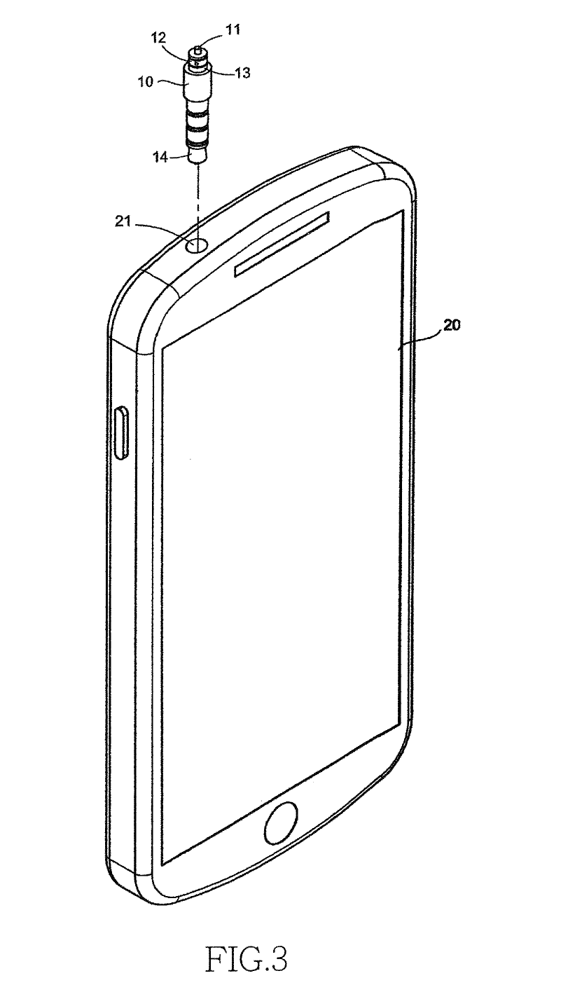

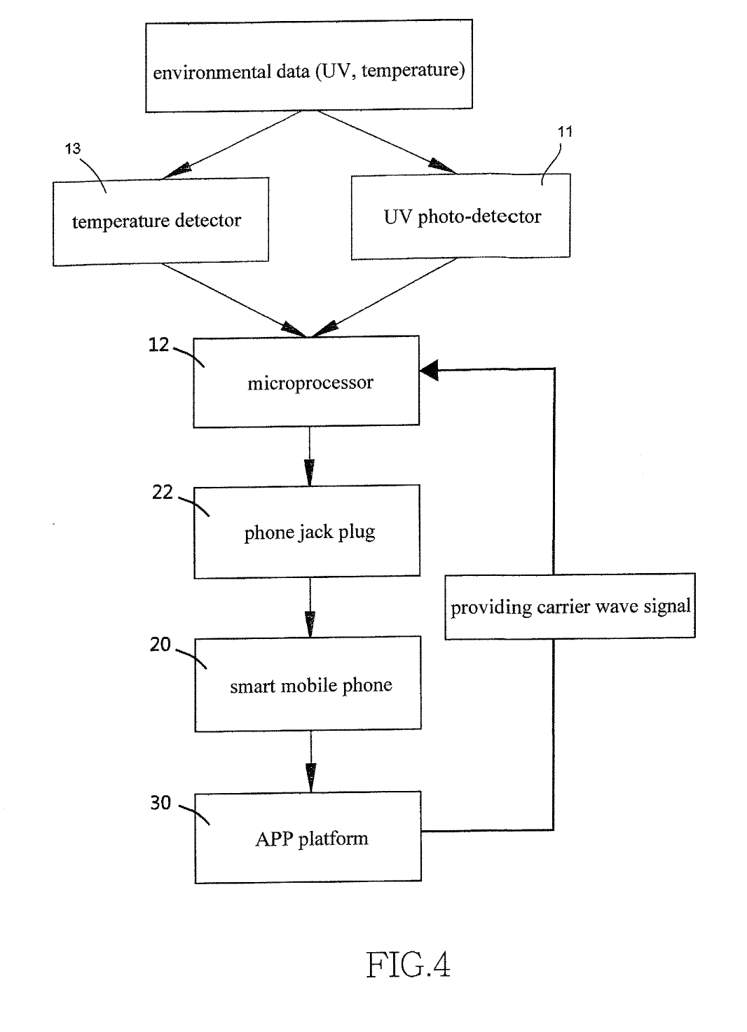

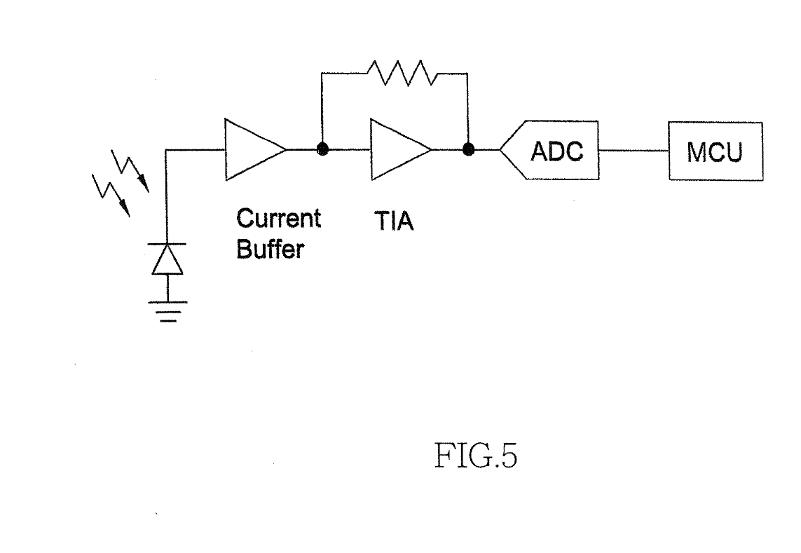

The present invention provides an instantaneous environment detection device and an application thereof, which comprises a detection device body that is capable of detecting temperature, humidity, and ultraviolet light and is operable in combination with positioning and computing measures provided in a portable electronic device to instantaneously acquire values of environment temperature, humidity, ultraviolet radiation and also to connect, via networks, with related databases and stores by means of a preset APP platform so as to uses the detection data to establish personal use data and commercial marketing statistics, making it convenient to achieve the function of instantaneously supplying correct needs and suggestion for shopping. The entire device is configured as shown in FIGS. 1-6, in which a device for detection is constructed as a pre-formed detection device body (10), which can be combined with an elongate bar like connection assembly, of which the entire outside configuration, according to the needs for coupling of different devices, can be subjected to beautifying modification, wherein an outermost top end is coupled with a UV band photo-detector (11) for detection of UV light of which a bottom is coupled to a microprocessor (12) for storing the light detection value acquired through the detection. The device body (10) has a middle portion to which a detector (13) is mounted for detecting and communicating environmental temperature and humidity with the microprocessor (12) so that the detected values of temperature and humidity are transmittable to and storable in the microprocessor (12), wherein a processing circuit includes detection ICs of ML-8511 or SI7013 or SH T 10, 11, 15, 21 to respectively detect and operatively control the values of UV light, temperature, and humidity. The device body (10) is extended, at the bottom thereof, to form a projecting slender metallic insertion bar (14) having a body having a top end made in circuit connection with the microprocessor (12). The entire device body (10) is provided, externally thereof, with a cap (15) for enclosing and protecting that can be made of a transparent material to achieve the purposes of security and protection when being carried, thereby constituting a complete basic outside configuration of the detection device body (10), allowing for convenient and direct insertion into a regular portable mobile electronic device, such as a tablet computer, a mobile phone, or a hand-held electronic device, which all allows for use with the insertion thereof. In the following, an embodiment of the present invention will be described with reference to a smart phone (20) that is taken as an example of operation herein. The device body (10) is directly inserted into an earphone socket (21) of a mobile phone (20) for assembling. It is of course possible to achieve connection by applying Bluetooth, WiFi, NFC wireless connection device so that a detection signal of the photo-detector (11) is subjected to modulation processing by the microprocessor (12). As illustrated in FIG. 5, the UV detector (11) comprises a visible light filter, a current buffer, a transimpedance amplifier (TIA), and an analog-to-digital converter (ADC) that are connected together to achieve instantaneous and positioning detection of UV light. The detection result of instantaneous data of temperature and UV light is provided, via a preset APP platform (30), as a signal, which is not limited to 8 k (particularly it being possible to provide detection of UV value below 1 to achieve detection of existence of hazard of UV light in the surrounding environment and it being also possible to do a detection operation for minor amount of UV under the irradiation of lighting with fluorescent light tubes in an indoor space so as to meet the need for UV radiation protection), for output modulation signal of the microprocessor (12), wherein being assisted by GPS positioning correction system built in the mobile phone (20), based to correction made for different positions according to the latitudes and longitudes thereof, the accuracy of measurement of UV light can be effectively and significantly improved. The output signal of the microprocessor (12), after modulation processing, is subjected to Manchester coding to be transmitted to the smart phone (20) for further processing, whereby the smart phone (20) can be directly display the current UV radiation value of sunlight and local temperature and humidity, after proper computation, on a screen of the mobile phone (20) to provide instantaneous detection of environmental conditions of local UV value, temperature, and humidity to the users so as to supply instantaneous detection data of the local living environmental conditions to the users, for achieving assistance to living for the users to do protection against sun burn and get aware of change and variation of temperature and humidity so as to ensure the purposes of maintaining activity quality and conformableness and security of living.

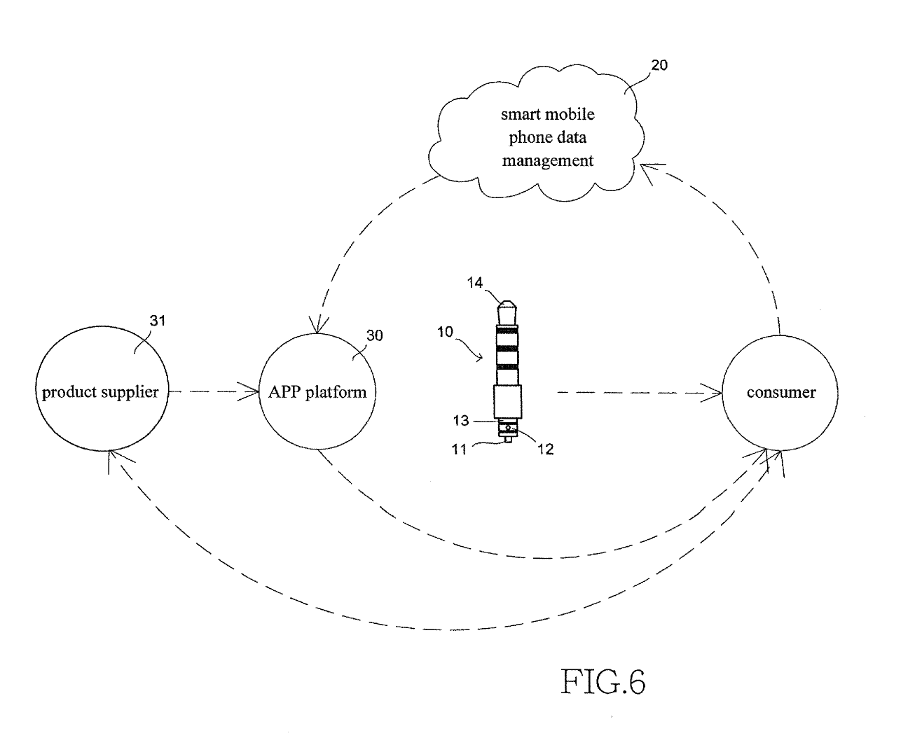

The features of use of the device-combinable easy-assembling detection device is that a pre-formed device body (10) is provided for direct connection with a portable electronic device, such as a widely available smart mobile phone (20), through direct insertion for combination therewith for use to provide a user with the capability of portable and instantaneous detection. The device body (10) has a top end to which a photo-detector (11) having UV band filter is mounted in advance to receive sunlight that is then subjected to processing by electronic circuits for photo-electrical conversion through diodes to provide an output current signal to a buffer for stabilization of the signal that is then fed to the microprocessor (12) built in the device body (10) for modulation processing thereby achieving detection and output of UV light of sunlight. Further, the temperature/humidity detector (13) provides detection result that is fed through built-in detection ICs of SI7013 or SH T 10, 11, 15, 21, subjected to a unique correction circuit to be supplied to the microprocessor (12) to form temporarily stored detection values. The detected UV value and temperature value are supplied to the microprocessor (12) to form temporarily stored detection values, whereby with an arrangement of a preset APP platform (30) of the smart mobile phone (20), the signal of the microprocessor is subjected to modulation processing and is also subjected to computation by built-in programs of the mobile phone (20) for displaying correct instantaneous position and correct values of UV light, temperature, and humidity. With easy detection and computation with a portable mobile device of the mobile phone (20) and to display the computed data directly on a screen of the mobile phone (20), through preset network of the APP platform (30), connection is made for transmission to a database, as shown in the connection arrangement of FIG. 6, where direct connection is made to facility-associated databases of sales or merchandise stores or libraries to enable transmission of concerned data back to the mobile device of the user, thereby providing the user with easy comparison for selection of corresponding protection values. Further, it is possible to cooperate with a care product supplier (31) in a practical application in order to provide, through connection via the APP platform (30), selection and suggestion of product purchasing so as to enable timely adjustment and correct application of sun lotion for activities in specific arrears of mountains and seashores in condition of strong intensity of UV light or sunlight thereby achieving the purposes of protection against the occurrence of sun burn or frostbite. Through the instantaneous detection of local data and establishing, investigation, and interaction of data of practical use, it is possible to establish complete and correct merchandise use and statistics database, which enables the merchandise product supplies (31) or a corresponding shop to do statistics of adaptability of products and habits of consumer groups to provide accumulated record data, allowing for further statistics and suggestion of purchasing and categorization of products, achieving the practical advantages of providing easy and conformable consumer living function and security. The entire detection device body (10) has a structure that is extremely simple, small in size, and easy to carry and has a practical operation of easy insertion for assembling and easy carrying and, when used in connection with a network connection platform, achieves a next-generation shopping mode. In view of the simple, practical, and correct automatic detection and protective use and multifunctional business association, the present invention provides a detection structure design that is novel and provides assistance to living conformableness.

In summary, the present invention provides a instantaneous environment detection device and an operation method thereof, which comprises a photo-detector that comprises a preset UV filter for detecting UV light and temperature/humidity detector and is combinable with a mobile electronic device, such as a mobile phone so as to be subjected to assistance and correction by a preset APP platform and built-in GPS positioning correction system to supply an out modulated signal through a built-in microprocessor that is subjected to coding to be transmitted to the smart mobile phone for processing for directly displaying detected radiation value of UV light and local temperature and humidity and can be connected with a network database for automatic reply for inquiry for statistics thereby providing a user with instantaneous detection of the environmental conditions and ensuring living comfortableness. The practical safety provided by the total protection realized with the present invention make the present invention a novel, creative, and practical design.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An instantaneous environment detection device comprising a detection device body to which devices for detecting UV light of sunlight and temperature and humidity are mounted and a portable hand-held electronic mobile device to receive insertion for coupling, characterized in that the device body comprises:
a photo-detector, which carries out light detection through a UV band filter and has a bottom connected to a microprocessor;
a temperature/humidity detector, which is mounted to a middle portion of the device body and is connected to the microprocessor; and
an insertion bar, which is an elongate slender metallic bar having a top end in circuit communication with the microprocessor and provided for insertion into the portable hand-held electronic mobile device, whereby through a built-in APP platform of the mobile device, an output modulated signal from the microprocessor is supplied to achieve the purpose of instantaneously detecting environmental temperature and humidity and UV value of sunlight.

2. The instantaneous environment detection device according to claim 1, wherein the photo-detector comprises a diode based photo-electric conversion device, which outputs an electrical current signal to a buffer for stabilization of the signal to be applied to the microprocessor of the device body in order to achieve an assembly for detecting UV light of sunlight.

3. The instantaneous environment detection device according to claim 1, wherein the APP platform provides a signal that is not limited to 8 k for forming an output modulation signal of the microprocessor.

4. The instantaneous environment detection device according to claim 1, wherein the UV photo-detector has a capability of detecting a UV value below 1 for detection of existence of UV light.

5. The instantaneous environment detection device according to claim 1, wherein the device body is made in the form of an elongate bar like connection assembly having an outside configuration variable in different for decoration.

6. The instantaneous environment detection device according to claim 1, wherein outside the device body, a cap is provided for enclosing, protecting and storing.

7. The instantaneous environment detection device according to claim 1, wherein the outside cap is made of a transparent material.

8. An instantaneous environment detection device and an operation method thereof, comprising a detection device body to which devices for detecting UV light of sunlight and temperature and humidity are mounted and a portable electronic mobile device to receive insertion for coupling and characterized in that an elongate slender metal insertion bar at one end of the device body is inserted into and coupled to the portable hand-held electronic mobile device so that through an APP platform built in the mobile device, an output modulation signal of a microprocessor is output via a network to a predetermined database for detection and processing, together with a preset returning function, associated detection comparison data being returned to be displayed on a screen of the mobile device to provide a user with corresponding protection selection reference and business statistics of shopping habits so as to achieve instantaneous detection of environmental temperature and humidity and UV value of sunlight and provide business service and effective protection and use.

9. The instantaneous environment detection device and the operation method thereof according to claim 8, wherein the database that is connected comprises a database related to product data of care product data supplier or library.

10. The instantaneous environment detection device and the operation method thereof according to claim 8, wherein when the detection data is connected and transmitted to the database, storage statistics is formed to provide statistic use of personal us habits and product development.
